(19) United States
(12) Patent Application Publication
(10) Pub. No.: US 2008/0150855 A1
(43) Pub. Date: Jun. 26, 2008

(54) LIQUID CRYSTAL DISPLAY

(75) Inventors: MING-KE CHEN, Shenzhen (CN); XIAO-ZHU CHEN, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/778,086

(22) Filed: Jul. 16, 2007

(30) Foreign Application Priority Data
Dec. 26, 2006 (CN) 200610201413.1

(51) Int. Cl. G09G 3/36

(52) U.S. Cl. 345/87

(57) ABSTRACT

A liquid crystal display includes a sensing device configured for sensing the presence or absence of a user and generating an indicating signal indicative of the presence or absence of the user, a controller configured to receive the indicating signal from the sensing device and produce a control signal in response to the indicating signal, and a switch being connected between a back-light power source and a back-light module, the switch being switched on or off in response to the control signal.

### BACKGROUND OF THE INVENTION

1. Field of the Invention

The present invention relates to liquid crystal displays. In particular, the present invention relates to a liquid crystal display having a power saving function.

2. Description of related art

Liquid Crystal Display (LCDs) are increasingly used in electronic devices such as computer systems, PDAs, mobile phones, etc. For such applications, LCDs have in fact become the standard display devices due to low power consumption, high reliability and low radiation.

In a computer system, a power saving function may be performed by a back-light timer, which cuts-off of power supplied to a back-light module of an LCD when the computer system has not been used for a period of time. This power management method is useful for saving electricity in portable computers having an LCD.

However, when the portable computer is in use, the user may be interrupted by some matter and leave the portable computer without turning it off or placing the computer system into some power management mode. In this case, the battery power is still being consumed while the user is away from the portable computer. Further, if a long period of time is set in the power management system, the power saving function may be ineffective in saving the battery power. The period of time set in the power management system must be modified to suit work conditions whenever required, which is inconvenient for the user.

What is needed is an LCD which has power saving function that can minimize unnecessary power consumption.

### SUMMARY OF THE INVENTION

An exemplary liquid crystal display includes a sensing device configured for sensing the presence or absence of a user and generating an indicating signal indicative of the presence or absence of the user, a controller configured to receive the indicating signal from the sensing device and produce a control signal in response to the indicating signal, and a switch being connected between a back-light power source and a back-light module, the switch being switched on or off in response to the control signal.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is a block diagram of a liquid crystal display according to a preferred embodiment of the present invention; and

FIG. 2 is a plane view of the liquid crystal display of FIG. 1.

### DETAILED DESCRIPTION OF THE INVENTION

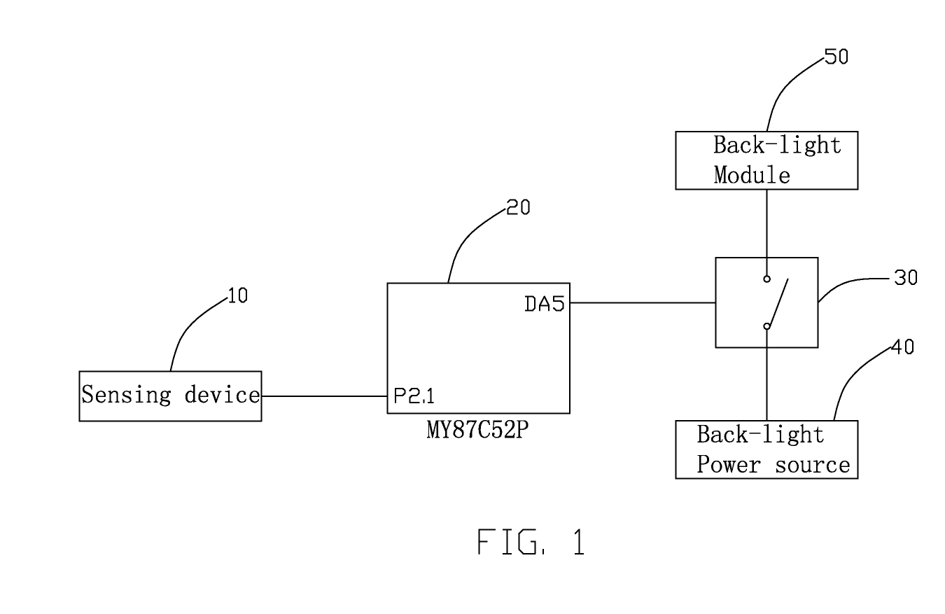

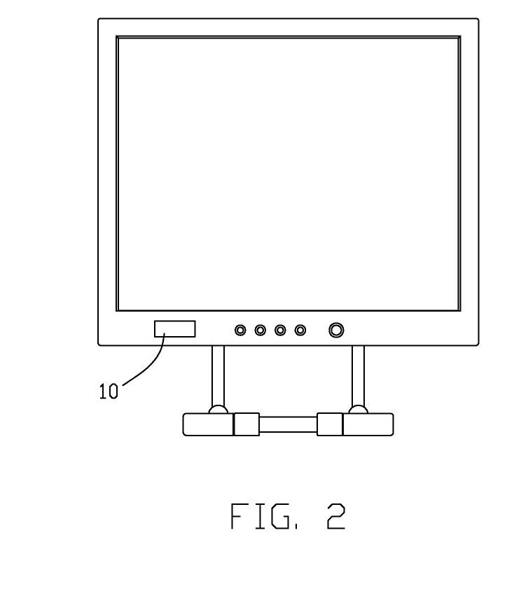

Referring to FIGS. 1 and 2, a liquid crystal display (LCD) according to a preferred embodiment of the present invention includes a sensing device 10, a controller 20, a switch 30, a back-light power source 40, and a back-light module 50.

The sensing device 10 is mounted to a lower portion of the LCD and is powered by a system power source which provides power to the LCD, and is for detecting whether a person is located within its sensing range or not. In this embodiment, the sensing device 10 is an infrared detector.

In this embodiment, the controller 20 includes a micro controller unit (MCU) MY87C52P, which includes a signal input terminal P2.1, and a signal output terminal DA5. The signal input terminal P2.1 of the controller 20 is connected to an output terminal of the sensing device 10.

The switch 30 includes a control terminal, an input terminal, and an output terminal. In this embodiment, the switch 30 is a switching transistor. The control terminal of the switch 30 is connected to the signal output terminal DA5 of the controller 20.

The back-light power source 40 is connected to the input terminal of the switch 30. The back-light module 50 is connected to the output terminal of the switch 30.

When the LCD is powered on, the controller 20 switches on the switch 30, and a power from the back-light power source 40 is provided to the back-light module 50 to make it work normally. Thus, a back light emitted by the back-light module 50 to a panel of the LCD.

If a user is not present in front of the LCD, the sensing device 10 detects this and through the output terminal of the sensing device 10 outputs a high level signal for indicating that the user is absent. The signal input terminal P2.1 of the controller 20 receives the high level indicating signal from the sensing device 10. The signal output terminal DA5 of the controller 20 outputs a first control signal in response to the high level signal from the sensing device 10. The first control signal is transmitted to the control terminal of the switch 30 to switch off the switch 30. Thus, the power of the back-light power source 40 is not provided to the back-light module 50, and the back-light module 50 does not work, which reduces the amount of power consumed by the LCD.

If the user later returns in front of the LCD, the sensing device 10 detects this and through the output terminal of the sensing device 10 outputs a low level signal for indicating that the user is present. The signal input terminal P2.1 of the controller 20 receives the low level signal from the sensing device 10. The signal output terminal DA5 of the controller 20 outputs a second control signal in response to the low level signal. The second control signal is transmitted to the control terminal of the switch 30 to switch on the switch 30. Thus, the power of the power source 40 is provided to the back-light module 50 again, and the back-light module 50 works normally.

In other embodiments, the sensing device 1 0 can be an ultrasonic detector.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display, comprising:
a sensing device configured for sensing the presence or absence of a user, and generating an indicating signal indicative of the presence or absence of the user;
a controller configured to receive the indicating signal from the sensing device and produce a control signal in response to the indicating signal; and
a switch being connected between a back-light power source and a back-light module, the switch being switched on or off in response to the control signal.

2. The liquid crystal display as described in claim 1, wherein the switch comprises a control terminal, an input terminal, and an output terminal, the control terminal of the switch is connected to a signal output terminal of the controller for receiving the control signal, the input terminal of the switch is connected to the back-light power source, and the output terminal of the switch is connected to the back-light module.

3. The liquid crystal display as described in claim 2, wherein the switch is a switching transistor.

4. The liquid crystal display as described in claim 1, wherein the sensing device is an infrared detector.

5. The liquid crystal display as described in claim 1, wherein the sensing device is an
ultrasonic detector.

6. The liquid crystal display as described in claim 1, wherein the sensing device is mounted to a lower portion of the liquid crystal display and is powered by a system power source configured to provide power to the liquid crystal display, when the liquid crystal display is powered on, the controller switches on the switch.

7. A method for saving power for a liquid crystal display, the method comprising:
a sensing device sensing the absence of a user within a sensing range;
the sensing device generating an indicating signal indicative of the absence of the user; and
a controller interrupting a back-light power to a back-light module of the liquid crystal display in response to the indicating signal.

8. The method as described in claim 7, wherein the sensing is done with an infrared signal.

9. The method as described in claim 7, wherein the sensing is done with an ultrasonic signal.
